(19) United States
(12) Patent Application Publication
(10) Pub. No.: US 2003/0145021 A1
(43) Pub. Date: Jul. 31, 2003

(54) Method and arrangement for serially aligning database transactions

(76) Inventor: Jarmo Parkkinen, Helsinki (FI)

Correspondence Address: YOUNG & THOMPSON, 745 SOUTH 23RD STREET 2ND FLOOR, ARLINGTON, VA, 22202

(21) Appl. No.: 10/059,140

(22) Filed: Jan. 31, 2002

(51) Int. Cl. G06F 17/30; G06F 12/00

(52) U.S. Cl. 707/204

(57) ABSTRACT

This invention relates to a method and an arrangement for serially aligning transactions (31, 32, 33) to co-ordinate the execution order of the transactions in a client/server or multi-database system. In particular the invention enables initiating one or multiple database operations in at least one second database when a transaction is ended in the first database. Further objects of this invention are to provide a method and an arrangement for enabling push and push-pull synchronization of data between master (510) and replica databases (520, 530, 540) utilizing transaction triggers. The invention also ensures that data is persistent and visible in one database when it is needed by another database or application software.

### TECHNICAL FIELD OF THE INVENTION

This invention relates to a method for serially aligning database transactions comprising at least two databases coupled to the associated database management system, comprising steps, in which the first transaction is initiated in the first database, at least one transaction trigger including attributes is linked into said first transaction and said first transaction is ended in the first database. This invention also relates to an arrangement for serially aligning database transactions comprising means for linking at least one said transaction trigger into the first transaction in the first database. This serial transaction alignment across databases enables distributing committed changes to data from one database into a number of other databases in an easily controllable manner.

### BACKGROUND OF THE INVENTION

The following notions are used in this application:

“Data management system” is an entity, which comprises one or more databases and/or data management systems, whereby the system is responsible for reading the data structures contained in the databases and/or data management systems and for changing these data structures.

“Database” is an information structure, which comprises one or more data elements, and the use of which is controlled by the data management system. The invention is applicable both in relational databases and in databases of other forms, such as in object oriented databases.

“Database operation” is an event, during which data elements are read from the database, during which data elements of the database are modified, during which data elements are removed from the database, and/or during which data elements are added to the database. Database operation can also be a call to a stored procedure or other piece of program code that is run by the database server.

“Database schema” is the structure of a database system, described in a formal language supported by the database management system (DBMS). In a relational database, the schema defines the tables, the fields in each table, and the relationships between fields and tables.

“Master database” is a logical database within a database instance in a database synchronization system that contains the primary version of synchronized/distributed data. A master database can have multiple replica databases.

“Replica database” is a logical database within a database instance in a database synchronization system that contains a full or partial copy of the master data.

“Synchronization” is an operation between replica and master databases in which changed data is exchanged between the databases. In one known embodiment, this means propagation of Intelligent Transactions from replica to master and subscribing to or refreshing a publication to download changed data from master to replica, as described in [1] EP 0 860 788. In this a “publication” is definition of a set of data or a set of data in a database catalogue that has been published in master database for synchronization to one or multiple replica databases.

“Push synchronization” is data synchronization operation where master database sends changed data to at least one replica database upon its own initiative.

“Pull synchronization” is data synchronization operation where replica database initiates the data synchronization process.

“Push-pull synchronization” is data synchronization operation where master database initiates the synchronization process by asking replica database to synchronize itself with the master.

“Transaction” is a plurality of database operations acting on the data elements. A transaction can also comprise further transactions. A “commit” operation signifies the completion of a successful transaction and a “rollback” operation signifies the unsuccessful termination of a transaction.

“Transaction trigger” is at least one database operation such as a stored procedure call that is defined inside an originating transaction but whose execution is deferred to take place at the end of the transaction. It is possible to specify whether the trigger fires at commit or rollback of the transaction. It is also possible to specify whether the trigger is fired right before or right after the end of the originating transaction. Once the transaction trigger fires, advantageously a new transaction is spawned for executing the database operations defined in the trigger.

There are three kinds of known methods in prior art for coordinating database transactions. In multi-database environment, a mechanism known as two-phase commit is available for a client application to control execution of related is available for a client application to control execution of related transactions in multiple databases. In single-database systems, a method called decoupled transactions is available for spawning a separate transaction in the same database if some triggering criteria are met. It is also possible to write a transaction coordinator application that writes data to one database and after successful commit, asks number of other databases to synchronize themselves with the first database. In this document, this method is called “application-controlled push synchronization”.

The two-phase commit mechanism has been developed to ensure data consistency in transactions that modify data in more than one database while providing concurrent processing of the changes. As shown in FIG. 1 the prior art two phase commit is a parallel system where in the first phase the application (120) issues a prepare to commit message in the transaction (11, 12) to all participating databases (122, 124) and after receipt of responses from all databases (122, 124) follows a second phase where the co-ordinating application issues a commit message if all nodes have sent “yes” responses and the transaction is completed and made permanent. In case of any “no” response received the co-ordinating application will issue an abort message and it will result in an aborting of the transaction to ensure data integrity across all the nodes in a database system. In this prior art two-phase commit mechanism the transaction (11, 12) sent by the application to all relevant databases typically includes data manipulation operations a) one or multiple insert, update and/or delete operations, b) prepare commit and c) commit.

Although the parallel operation is an advantage of the two-phase commit system it also degrades the availability of data in the database system and requires complex error handling logic. Updating databases requires successful concurrent communication to all databases in the system. The changes specified by the transaction to data in a database system are applied and confirmed separately to all databases in the system. If any of the participating databases is not available during the transaction, the transaction cannot be completed in any of the participating databases. This means that the system availability is easily affected by server or network outages. This also means that data can be processed in one database system only at a time before changes specified by the transaction are applied to another database system to ensure data integrity across the whole network. Hence the main disadvantages of the two-phase commit are in default of availability and complex error handling.

In today's database systems serial alignment of transactions can be done at database level when only one database is involved or at the application level when multiple databases are involved. The prior art serial approach for aligning transactions within a single database is shown in FIG. 2a. It is known from the document [2] “Active Database Systems: Triggers and Rules For Advanced Database Processing” edited by Widom and Ceri (page 21) that coupling modes are used to specify the relationship between the execution of rule components (i.e. event, condition and action) and database transactions. One of the coupling modes mentioned is called a decoupled mode which takes place in a separate transaction and this mode can be subdivided into dependent and independent decoupled. In the dependent decoupled mode the separate transaction isn't spawned unless the original transaction commits and in the independent decoupled mode the separate transaction is spawned regardless of whether the original transaction commits. This method provides a solution for aligning transactions serially within one database but it does not provide a solution for distributing changed data across multiple database servers.

As shown in FIG. 2a in a dependent decoupled transaction schema according to prior art, at first the client application 120 begins a new transaction 21, described as a box 25, in the database 122. Once the transaction 25 is active, the client application instructs the database server to perform one or multiple database operations such as insert a row to the database. The client application can also define one or multiple triggering rules 29 in the transaction 25. These triggering rules are evaluated for example when the transaction commits. If the trigger fires, it initiates a second new transaction 24, so called decoupled transaction 27, that can perform operations in the database defined by the rule.

The FIG. 2b shows Application-coordinated push synchronization scheme according to prior art, at first a transaction (21) consisting operations “insert” and “commit” is transmitted to the first database (122) by the application (120). The second transaction (22) sent by the application to the second database (124) consists command “run synchronization”. After before mentioned transactions are completed the synchronization transaction (23) is enacted between the databases and the synchronization is run from the second database with the first database. This kind of serial transaction is quite reliable, because transactions are coordinated by a central application node in a serial manner and the first database can be updated even if second databases are not available at the time of update. This kind of approach needs anyhow complicated application software development. Hence the main disadvantage in decoupled mode is application complexity.

The problem in distributed database systems is that a serial transaction functionality that affects data of more than one database has to be implemented in the application level. For this reason in prior art methods and arrangements for co-ordinating execution order of transactions in a client/server and multi-database systems data and associated hardware is handled separately in applications. The prior art solutions do not make it possible to launch services in transaction context across multiple database servers at DBMS level, especially when services are bound together with push synchronization.

### SUMMARY OF THE INVENTION

An object of this invention is to provide a method and arrangement for improving the performance and controllability of multi-database systems by aligning serial transactions to co-ordinate the execution order of transactions and establishing direct cooperation between multiple databases. This data management concerns a method for serially aligning database transactions to ensure that data that is written to the database in a transaction is persistent and visible in one database when it is needed by another database or application.

An object of this invention is to provide a method and arrangement for synchronization of data between databases utilizing the transaction triggers as a synchronization initiation mechanism. When the trigger fires in the first database, it initiates advantageously another transaction that performs a remote procedure call or other database operation in the second database. This operation can send data to the second database in its parameters or it can make the second database to synchronize itself with the initiating database. Sending changed data from the first database to the second database is called “push synchronization”. If the second database synchronizes itself with the first database upon its own initiation, the operation is called “pull synchronization”. If the first database asks the second database to synchronize itself with the first database, the operation is called “push-pull synchronization”. The method described here is suitable for initiation of push and push-pull synchronization.

Yet another object of this invention is to provide a method for allowing a data storage to inform an embedded configuration management software of hardware device that a transactionally consistent set of data has been changed. This allows hardware device to change its configuration to reflect the changed data right after the data has been committed in the database.

Further object of this invention is that the type of said transaction trigger can be in any of the following four forms, namely after commit trigger, before commit trigger, after rollback trigger or before rollback trigger. Although in most embodiments of this invention, such as push-pull synchronization, the transaction trigger is advantageously of “after commit” type, in this application all the references made to expression “transaction trigger” in connection with the invention hold true as well for any of the four possible forms mentioned above. Expressions “committed” and “rolled back” related to the invention are included in the verb “ended”.

The main advantage of this invention is that it provides a way with which distributed transaction coordination previously done by the application may be outsourced to the data management software. This means that all database connections from the application are centered to one database and thus smaller number of connections are required compared to two-phase commit systems or application controlled push synchronization systems. Consequently this invention also saves a need for developing separate application processes for different databases e.g. polling possible changes in configuration data of a device, which facilitates the tedious work of application and system development. Also the error handling is improved according to the invention, because less error sensitive code writing is needed in the application level. Further advantage is that the processing queues i.e. the order of synchronizations are handled outside of the application. The invention also offers all the benefits of parallel operation as the database management systems typically are capable of executing tasks in a parallel fashion.

This invention enhances the co-operation and data exchange between database nodes by allowing remote database operations such as data synchronization occur in a second database when a transaction commits in the first database. This functionality is important in network infrastructure where the configuration matrices of devices are growing exponentially and the complexity of configuration data that is stored in the local databases of the devices is increasing. Also, data dependencies between the devices are getting more complex. In this kind of systems, it is of great importance that all nodes of the system have the right and consistent data in them and that updates to the data are delivered to the relevant databases in a timely and efficient manner.

The method of the present invention is useful in serial alignment of database transactions comprising at least two databases coupled to the associated database management system and is characterized in that, it comprises the step, in which at least one said transaction trigger is fired in at least one first database, and at least one second transaction is initiated in the first database to invoke a remote database operation in at least one second database according to at least some of the attributes in the trigger.

The method of the present invention is also useful in serial alignment of database transactions comprising at least two databases coupled to the associated database management system and is characterized in that, it comprises the step, in which at least one said trigger is fired in at least one first database, and at least one second transaction is initiated to synchronize data in at least one second database from at least one first database according to at least some of the attributes in the trigger.

The present invention also relates to an arrangement for aligning serial database transactions comprising at least two databases and associated database management system, characterized in that, it comprises means for initiating at least one second transaction to push data into at least one second database according to at least some of the attributes in the trigger after said first transaction is successfully ended in at least one first database and thereafter said trigger fired in at least one first database.

The present invention also relates to an arrangement for aligning serial database transactions comprising at least two databases and associated database management system, characterized in that, it comprises means for initiating at least one second transaction to synchronize data in at least one second database from at least one first database according to at least some of the attributes in the trigger after said first transaction is successfully ended in at least one first database and thereafter said trigger fired in at least one first database.

One preferred embodiment of the invention is to enable a combination of master-initiated push-style and replica-requested pull-style synchronization of data between the master and replica databases. Another embodiment of the invention is to enable the data management server (data storage) to inform embedded configuration management software of hardware devices that a transactionally consistent set of data in the first database (source) has been changed and this allows the hardware device in question to change its configuration accordingly after the changed data has been synchronized and committed in the second database (target) that runs in the hardware device. One preferable embodiment of this is the second database being part of a network router coupled to SONET application and line card.

The best mode of the invention is considered to enable a push-pull synchronization of data in multi-database environment.

Some embodiments of the invention are described in the dependent claims.

### BRIEF DESCRIPTION OF THE DRAWINGS

The foregoing and other objects, features and advantages of this invention will be apparent from the following more particular description of the preferred embodiments of the invention as illustrated in the accompanying drawings.

FIG. 1. is a block diagram of a database arrangement using two-phase commit mechanism according to the prior art.

FIG. 2a. is a block diagram of a dependent decoupled transaction system according to the prior art.

FIG. 2b. is a block diagram of a database arrangement using application-controlled push synchronization mechanism according to the prior art.

FIG. 3. is a block diagram of a database arrangement according to the present invention.

FIG. 4. is a flow diagram of a method of the present invention.

FIG. 5. is a block diagram of an embodiment for push-pull synchronizing several source databases according to the present invention.

FIG. 6. is a block diagram of an embodiment for network router application according to the present invention.

FIG. 7. is a flow diagram of an embodiment for network router application according to the present invention.

FIG. 8. is a flow diagram of a method for simultaneously configuring multiple nodes in a network according to an embodiment of the present invention.

### DETAILED DESCRIPTION

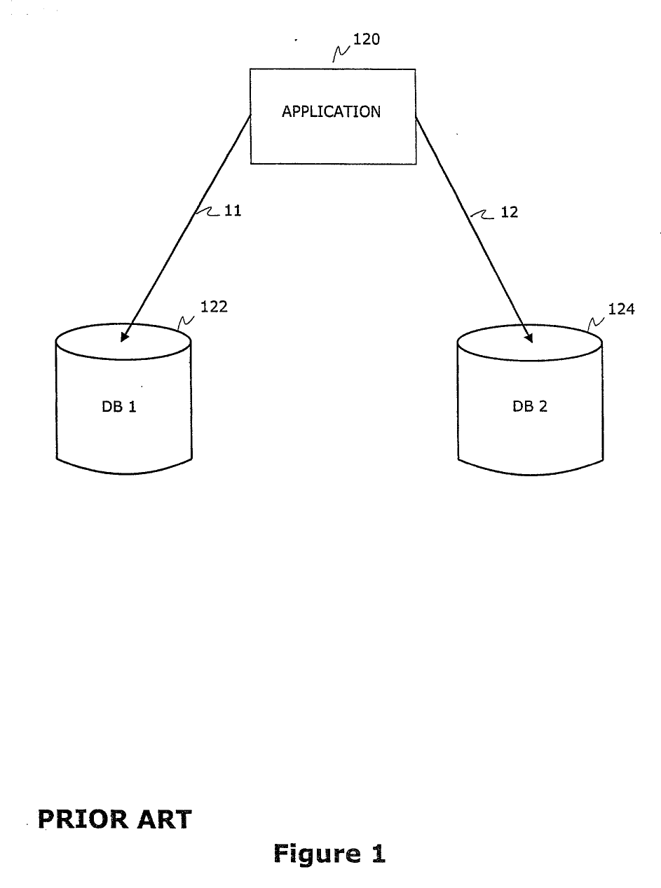

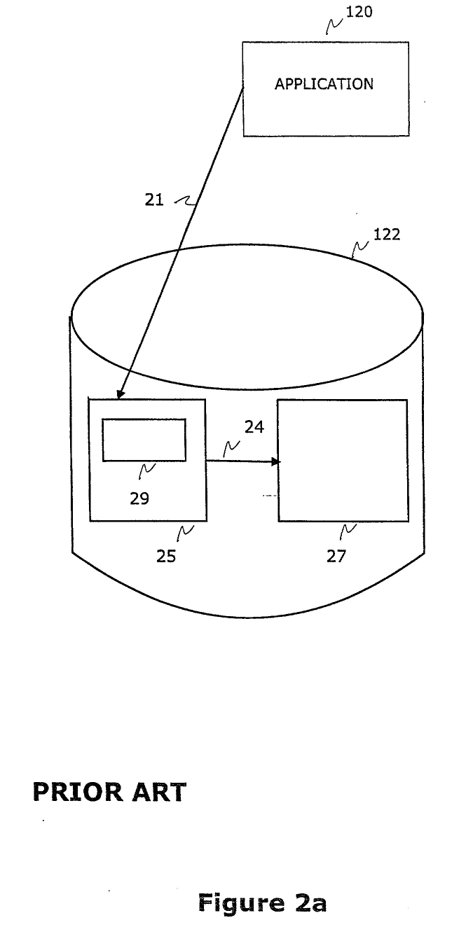

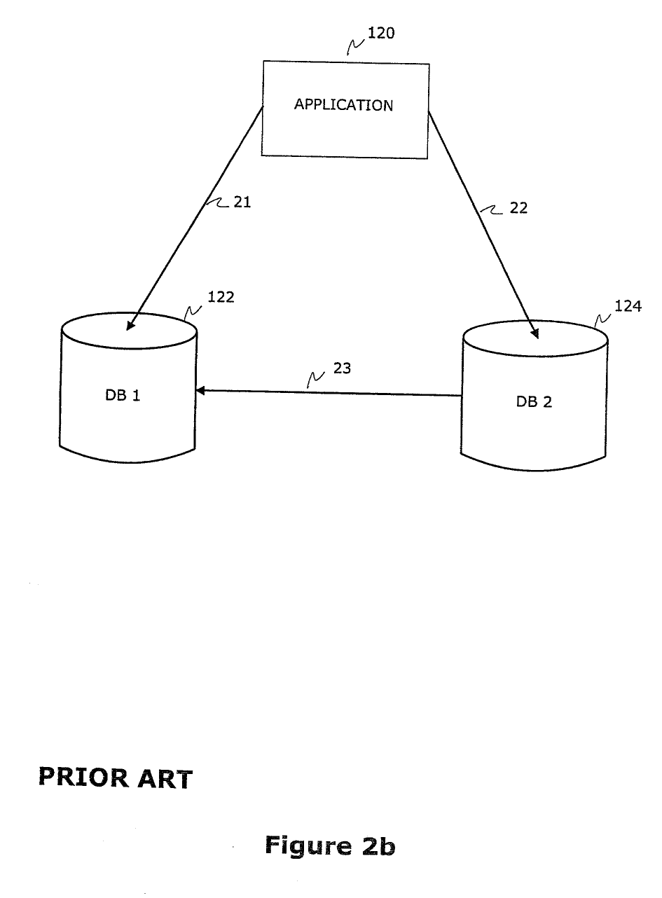

In connection with the description of the prior art above reference was made to the FIGS. 1, 2a and 2b, so in the following detailed description of the present invention and its preferred embodiments reference is made primarily to the other figures.

The master-initiated push-pull synchronization is useful in scenarios where a transaction in the master database causes a need for one or multiple replica databases to refresh themselves by means of data synchronization. The transaction can be e.g. a change of a certain data that needs to be further sent to at least one replica database. The “after commit trigger” functionality is an essential part of this mechanism.

The “after commit” trigger is a deferred call to a stored procedure or other piece of program code that is automatically executed in a separate transaction whenever the trigger fires. The trigger fires when the transaction where the deferred procedure call was defined, ends in a way that was specified in the trigger definition. For example, if the trigger was defined to be of type “after commit”, it is fired after successful commit of the transaction. When the trigger fires, the server executes the procedure with the parameters specified in the deferred call. For executing the procedure, a separate database connection is advantageously established to allow concurrent execution of other user transactions while the triggered transaction is executing.

In general the method of the present invention comprises four steps the first of which is that the transaction is initiated. Within this transaction, the transaction trigger, i.e. a deferred call to a remote stored procedure or other piece of program code, is buffered into the transaction. When the transaction is ended i.e. committed or rolled back the transaction trigger fires. After this a new transaction follows in a separate database connection. This new transaction can now execute the remote procedure call with its parameters in at least one second database to push changed data to these databases or request them to synchronize with the first database.

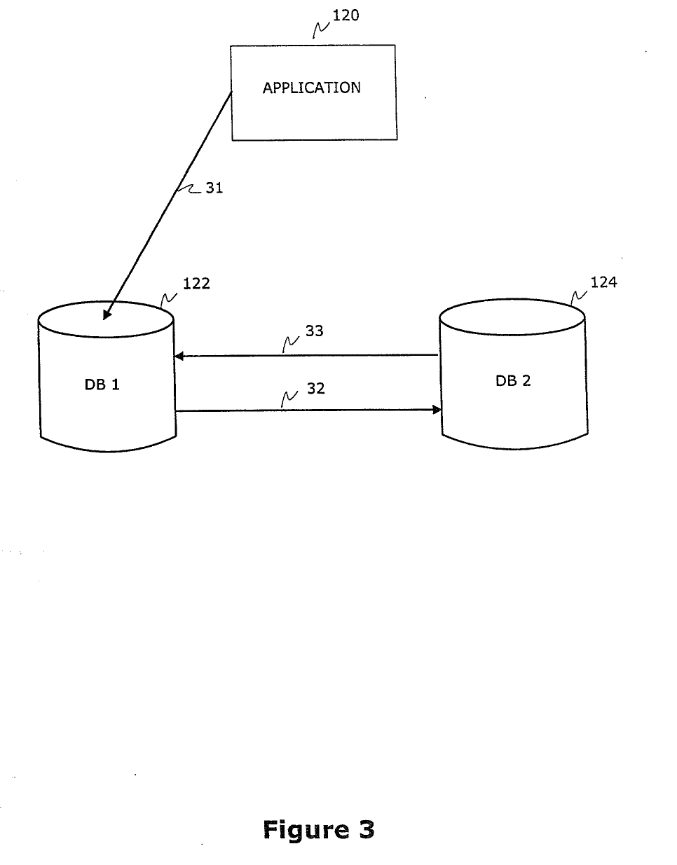

In FIG. 3 a block diagram illustrates a transaction scheme utilizing transaction trigger mechanism in the synchronization process according to the present invention. The first transaction 31 sent by the application 120 to the first database (DB1) 122 consists at least operations “insert/update/delete”, “define trigger” and “commit”. The content of this first transaction differs from the transaction 11 in case of two-phase commit mechanism illustrated in FIG. 1 that there is a transaction trigger linked into it 31. In the transaction scheme of the invention in the FIG. 3 the second transaction 32 is ready to act immediately when said trigger fires before or after the first transaction has successfully committed and/or rolled back. This second transaction is advantageously executed in a separate database connection. In other words the beginning of the second transaction is delayed by the trigger until the first transaction is committed, rolled back, aborted or responded in some other way or the first transaction has not responded at all. It is also possible to trigger N transactions to begin at the same time after the first transaction is committed or rolled back. Each of these N deferred transactions can be executed in their own database connections. This way, the triggered transactions can each run in the server concurrently once the triggering transaction ends.

At the moment the trigger fires the transmitted refresh data already exist and is available in DB1. The second transaction initiated after the trigger fires will push this refresh data from DB1 to the second database (DB2) 124 using a remote database operation or it initiates synchronization process where DB2 begins to request synchronization data (33) from DB1 according to parameters passed to DB2 in the remote database operation. In the latter scheme operation of DB2 is independent and it can decide when to refresh on the basis of application state once it receives the synchronization initiation request from the DB1.

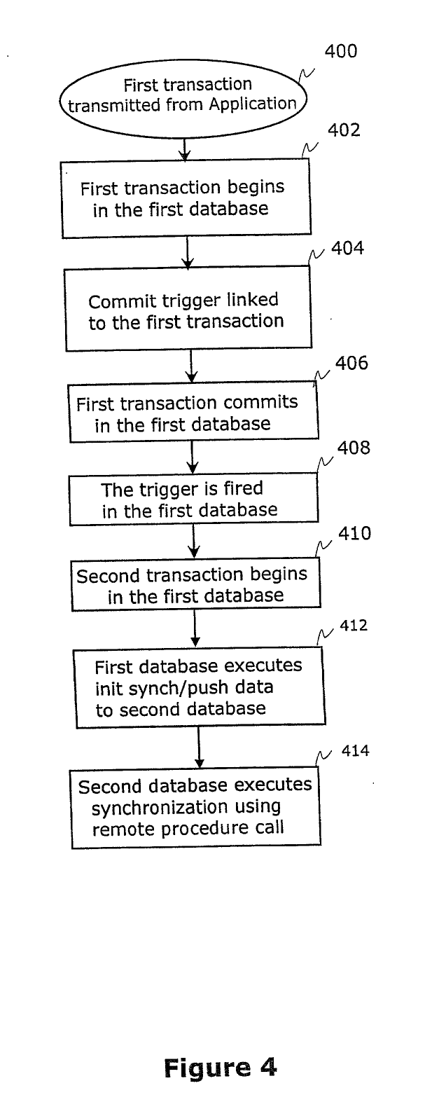

FIG. 4 represents a corresponding method according to the invention described in FIG. 3 in the form of a flow chart. In step 400 a first transaction including at least one insert/update/delete, define trigger and commit operations is sent by the application to DB1. Next step 402 shows the first transaction beginning in DB1. As being part of the first transaction a defined transaction trigger, namely after commit trigger, is represented in separate step 404 clarifying that it is linked into the first transaction. Then in step 406 the first transaction is completed in DB1. When the first transaction is committed the trigger fires in step 408 and the second transaction begins in the DB1 advantageously in another database connection in step 410. This second transaction executes the remote procedure call defined by the transaction trigger. The remote procedure call executes a procedure in DB2 412. This procedure causes DB2 to execute synchronization with DB1 414.

A term “push-pull-style” or “master-initiated” means that the source (e.g. master database) issues e.g. a remote procedure call or other signalling event, with data values as arguments whenever it wants the target (e.g. replica database) to synchronize itself with the source. This can occur for example whenever new data in the source database is available. According to the invention at least one transaction occurring in at least one database server is serially aligned before or after the end of a triggering transaction in a database server. This serially aligned transaction executes at least one remote database operation that notifies the target databases about the need to synchronize with the source. Then the target databases may decide on their own when to start the synchronization by sending a synchronization request to the source database. The actual synchronization takes place in the pull-mode.

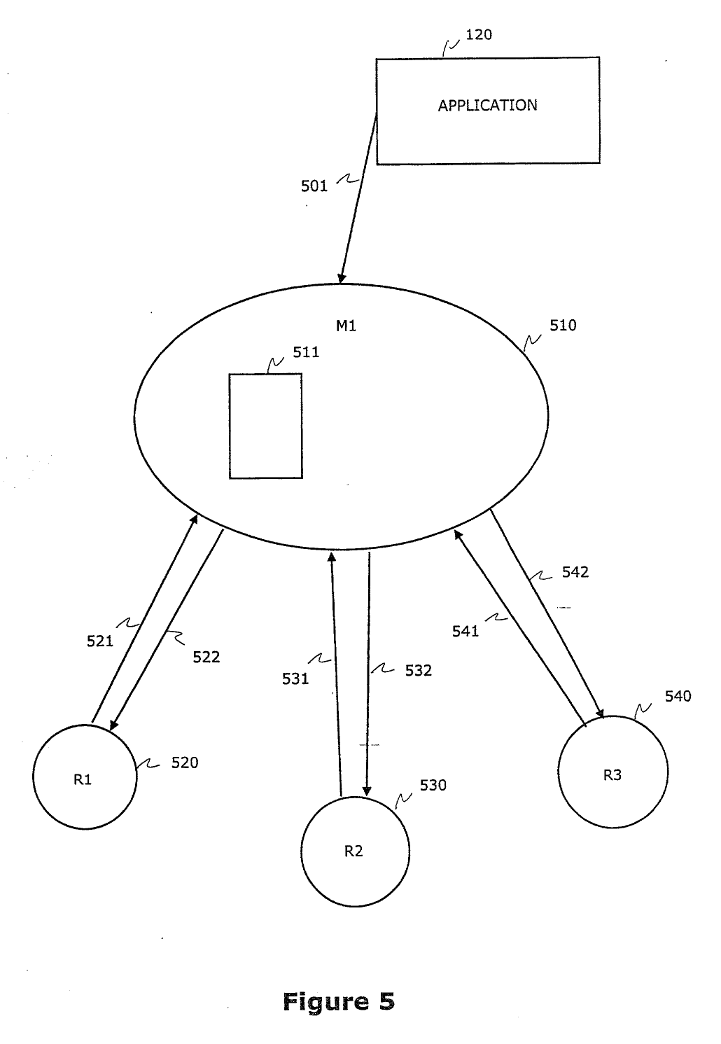

One embodiment of the present invention is to enable push-pull-style synchronization of data between the master and replica databases. In the FIG. 5 is illustrated an exemplary arrangement for a push-pull synchronization mechanism utilizing the transaction triggers of after commit type according to the present invention. This arrangement for multi-database push-pull synchronization comprises one master database (M1) 510 and several replica databases (R1-R3) 520, 530, 540.

As an example this invention allows managing device configuration data in a master database and distributing it in a controlled manner into replica databases that run on the managed hardware. This allows the master database 510 to inform the replica database of a hardware device that a transactionally consistent set of data in database has been changed. When data is requested by application 120 to be changed in a database, hardware should only be prepared for a new state where all operations have been successfully and persistently completed. With after commit database trigger the databases of devices are aware of assigning new statuses effectively. This allows a hardware device to change its configuration to reflect the changed data right after the data has been committed in the master database and synchronized to the replica database of the device. The present invention does not expect the devices to support the aforesaid two-phase commit protocol to ensure data integrity.

FIG. 5 shows the inventive arrangement for push-pull synchronization of data between the master 510 and replica 520, 530, 540 databases. The master database server comprises a data storage 511 for storing data of the database and buffering transaction triggers of after commit type. The transaction trigger invokes a remote database operation that may implement push or push-pull-style synchronization.

The push-style synchronization means that the master database M1 sends the changes occurring in the M1 into all the relevant replica databases as remote database operations so that all replicated copies are always up-to-date and identical. Push-pull-style synchronization means that the master database M1 sends notifications 522, 532, 542 to the replica databases about the relevant data changes. Then the replica databases may decide on their own when to start the synchronization procedure by sending a request 521, 531, 541 to the master database. The actual synchronization takes place in the pull-mode. This push-pull synchronization is performed for example according to the standard SyncML synchronization protocol using server alerted synchronization scenario in some embodiments. In FIG. 5 operations insert/update/delete, define transaction trigger and commit transaction 501 are sent by application 120. Then transaction trigger is fired and “init synch” remote procedure call is sent as a notification from M1 to R1, R2 and R3 522, 532, 542 for initiating synchronization process and R1, R2 and R3 send a request for synchronization data to M1 521, 531, 541 when elected to do so independently on application. Finally synchronization data is sent to all replicas 522, 532, 542.

As an example of the push-pull synchronization mechanism utilizing the transaction trigger of after commit type according to the invention is to follow. To attain the push-pull synchronization (SyncPush) “start” and “call” statements can be used and a user can define these statements as explained hereinafter. The scenario assumed in this example is similar to the FIG. 5 with the exception that only replicas R1 ja R2 are participatory.

The following steps have to be gone through to attain the SyncPush functionality. In the first place a procedure P_{M} must be defined in the master database M1. This procedure P_{M} must include the remote procedure call statements for all replicas which the master wants to synchronize:

“call Pᵣ₁ at R1”, and

“call Pᵣ₂ at R2”

In the second phase a procedure Pᵣ₁ for replica R1 must be defined. If the master M1 is to invoke the said Pᵣ₁ in more than one replica, the Pᵣ₁ should be defined for every participatory replica of interest. An example of a replica procedure is shown hereinafter.

The third step is to define the transaction trigger of after commit type in all those transactions after which the procedure P_{M} must be executed. These may include individual data manipulation operations such as “insert”, “update” and “delete” on specific tables. The transaction trigger is defined using the following statement:

“start after commit call P_{M}”

The final step is to grant “execute” authority on Pᵣ₁ to master M1 in every replica database involved.

Sales application to follow is described as a more detailed example of the push synchronization mechanism. In this exemplary sales application a master database contains a table “customer” and an attribute “salesman” in that same table. Every replica database contains its own “salesman” partition of master's data. Every time when “salesman” of “customer” changes the affected replicas should be notified because this operation causes the affected customer of a salesman to be added to the replica database of one salesman and removed from the database of another salesman. The following conclusions are to be drawn and notifications made in this case. If any of the customers are assigned to a new salesman the replica databases of both old and new salesmen have to be notified. Attention must be paid to two things the first of which is that also “insert” and “delete” triggers should be defined and the second that the “after commit trigger” functions are defined by the “start” commands for initiating a transaction. To do all this the following program has to be written:

CREATE TRIGGER T_CUST_AFTERUPDATE ON CUSTOMER

AFTER UPDATE
REFERENCING NEW SALESMAN AS NEW_SALESMAN,
REFERENCING OLD SALESMAN AS OLD_SALESMAN

BEGIN

IF NEW_SALESMAN <> OLD_SALESMAN THEN

START AFTER COMMIT

CALL NOTIFY_REPLICA(OLD_SALESMAN)

START AFTER COMMIT

CALL NOTIFY_REPLICA (NEW_SALESMAN)

ENDIF

END;

Next in this sales application all customers in a sales area “CA” are assigned to “Mike” by a user:

UPDATE CUSTOMER SET SALESMAN=‘Mike’ WHERE

SALES_AREA=‘CA’;

COMMIT WORK;

The master database contains a following procedure that makes a remote procedure call to a replica database:

CREATE PROCEDURE NOTIFY_REPLICA (salesman VARCHAR)
BEGIN

CALL SYNCH_CUST (salesman) AT salesman;
COMMIT WORK;

END

Each participatory replica database contains a following procedure to synchronize the replica database with the master database:

CREATE PROCEDURE SYNCH_CUST (salesman VARCHAR)
BEGIN

MESSAGE s BEGIN;
MESSAGE s APPEND

SUBSCRIBE CUSTOMERS_BY_SALESMAN (salesman);

MESSAGE s END;
COMMIT WORK;
MESSAGE s FORWARD TIMEOUT FOREVER;
COMMIT WORK;

END

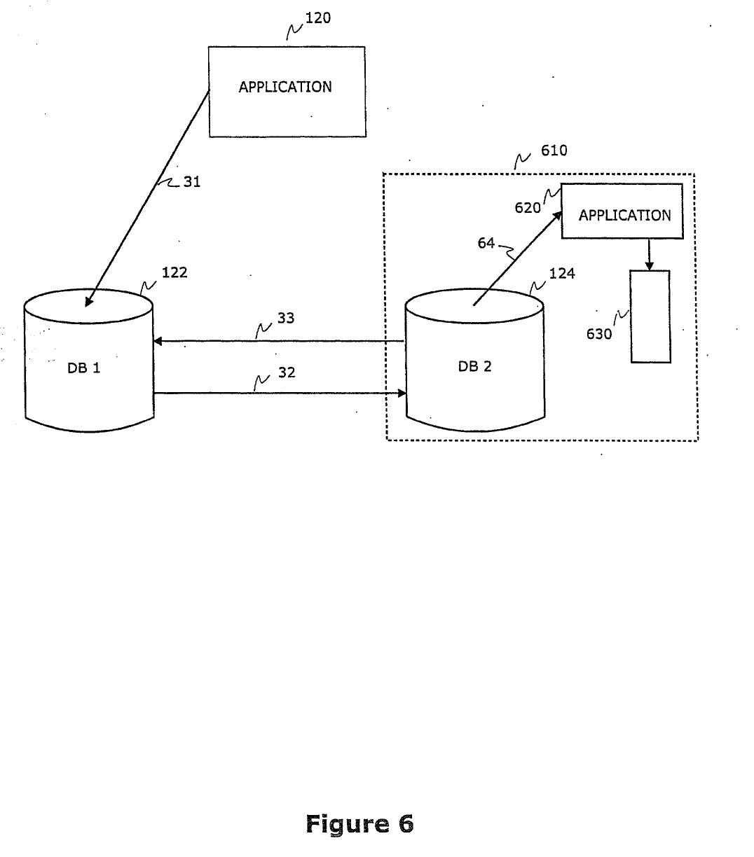

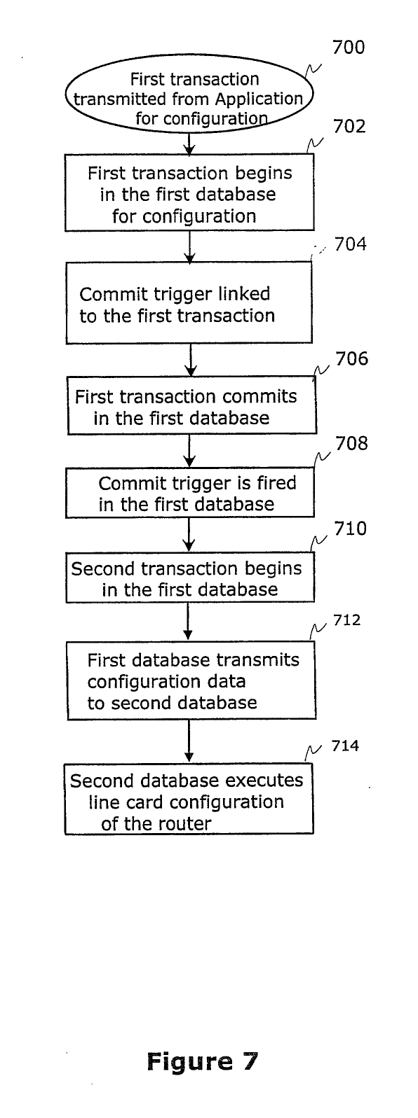

FIG. 6 illustrates an arrangement for configuring hardware devices in a network according to one embodiment of the invention described in FIG. 3. FIG. 7 is a flow diagram of the corresponding arrangement. In FIG. 6 the application 120 sends the first transaction 31 to the first database (DB1) 122 which acts as a master database in this case. According to step 702 this first transaction starts in DB1 and the configuration data transmitted from application is stored in DB1. This transaction consists operations insert/update/delete, define transaction trigger and commit, and transaction trigger is linked into this transaction as shown in step 704 in FIG. 7. When all required modifications are completed in DB1 the first transaction commits in DB1 as shown in step 706. Immediately after this follows next step 708 in which the transaction trigger fires in DB1 and the second transaction 32 begins in DB1 in a separate database connection as shown in step 710. The second database (DB2), a replica database in this case, receives the remote procedure call issued by this second transaction which consists notification to initiate synchronization. As shown in FIG. 6 DB2 is part of network router 610 associated with router application software 620 and line card 630. The embedded configuration management software of a device 620 is automatically notified by the database server when a new consistent set of configuration is available at the replica database server. Configuration data is managed by the database engine utilizing the transactional capabilities of the engine. Then DB2 decides whether or not the router and its line card needs configuration data. In case the router needs updating DB2 sends a request 33 for synchronization data to DB1 and then DB1 answers with configuration data 32 to DB2 (step 712 in FIG. 7). The associated managing system in DB2 then sends an event 64 concerning new configuration data to the router application 620 which then updates the relevant line card in the network router based on the committed data of the DB2. In the flow diagram of FIG. 7 this is shown in step 714. During the whole configuration process DB2 operates separately from the main application 120.

In the case of configuration data management the transaction triggers of after commit type can be used to notify a hardware device about persistent multi-step changes in the configuration data of a device managed by a database server. As earlier mentioned most often the multi-step atomicity is an important requirement for managing the device configuration. For example when routing tables of a router are updated there is usually a need for multiple entries in the table to be updated. Moreover, there are multiple routers whose routing tables are affected. This plurality of updates must be atomic and the routing information must be applied to the affected devices only in case when all related updates in all affected devices have successfully been completed.

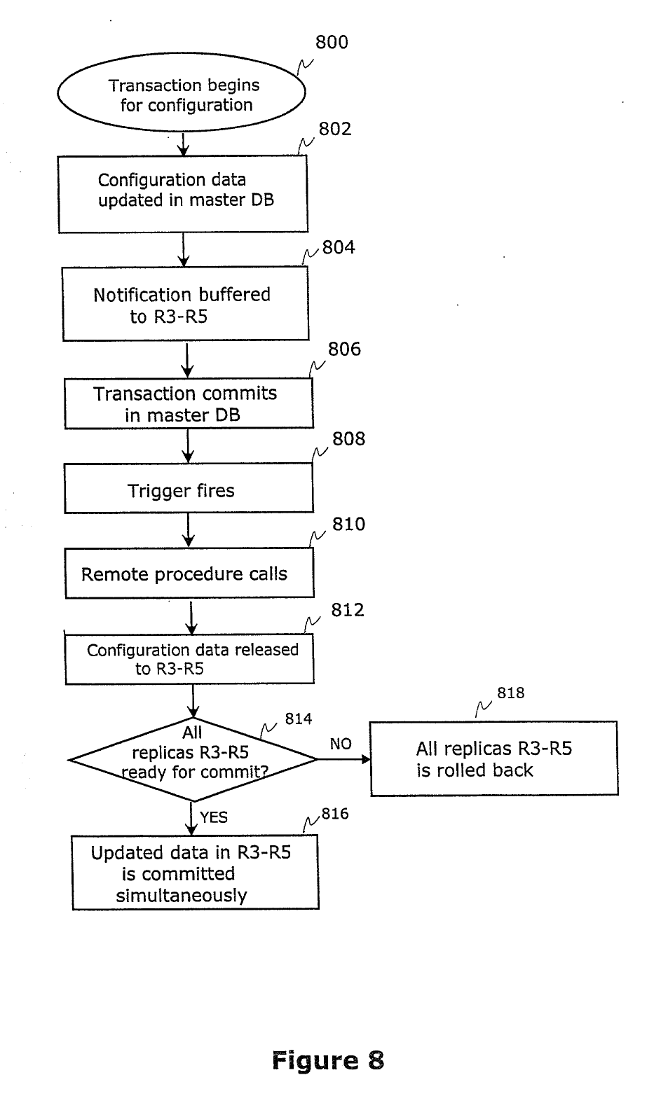

FIG. 8 shows a flow diagram of a method for configuring multiple nodes in a network according to another embodiment of the present invention. A system comprises N devices, like switches, routers, base stations, wireless edge boxes etc., in an optical ring network and there is an actual need to configure more than one device in a way that all the specified devices get the changes in one go at the same time. It is also needed that transactional integrity maintains reliable between the separate local databases on these devices. As a functional example of this kind of system can be considered N boxes (nodes) related to a SONET optical ring forming a metropolitan level network. In this network e.g. boxes 1, 3, 4 and 5 out of 16 are configured to create an end-to-end connection (tunnel) starting from box 1, going through 3 and 4, and ending in box 5. Boxes 1, 3-5 are also related to a wireless network with an agreement to use certain frequencies with certain ratios e.g. 45 percent of frequency 100 MHz is used for download speed. Whenever this configuration is changed, all the nodes configured in this way should accept the change at the same time. Otherwise the network ends up with an unknown or incorrectly functioning state.

According to the embodiment of the invention as shown in FIG. 8, in step 800 a transaction for configuration begins and in step 810 the configuration data is updated in a transaction in the master database of the configuration management system. In this transaction, an after commit trigger for notifying the affected replicas (R3-R5) is defined in step 804. After the transaction commits in the master database in step 806, the procedure invoked by the after commit trigger in step 808 invokes according to step 810 three remote procedure calls, one for each replica database affected. In step 812 these procedures download the changed data from the master database to the replicas using push-pull-style data synchronization but don't yet commit the new data in the replicas. In step 814 the data has now been downloaded to the replicas but it is not yet visible to the configuration management applications of the devices because the transactions in the replica databases have not been committed yet. If the synchronization operation is successful in all replicas, the procedure in the master database instructs each of the replicas to commit their transactions using separate remote procedure call or SQL statement as shown in step 816. If the synchronization operation is unsuccessful in any of the replicas, the procedure in the master database instructs rollbacks in all three replicas in step 818. This way the configuration upgrade either occurs in all three devices or in none of them. Additionally, the master database is always aware of the status of each of the replicas.

The described method and arrangement of the invention is independent of the communication technology and the client/server or multi-database system. The master database and replica database arrangements can be connected to each other to communicate transactions 521, 522, 531, 532, 541, 542 (see FIG. 5) by any known suitable data transfer system such as cable, wireless, Internet or other communication system or by any combination of these when the connection is established. A storage medium 511 is a memory or a disk in this application.

A system according to the invention can be implemented by a person skilled in the art with state of the art information and communication technology components. A person skilled in the art can implement the functions according to the invention by arranging and programming such components to realize the inventive functions.

For example, it is preferable to implement the invention to work in a telecommunication system which is compliant with, but is not limited to, at least one of the following: TCP/IP, CDMA, GSM, HSCSD, GPRS, WCDMA, EDGE, UMTS, Bluetooth, Teldesic, Iridium, Inmarsat, WLAN, DIGI-TV and imode.

It is also preferable to use a standardized operating system in the terminals and servers. The operating system of a terminal can be, but is not limited to, for example Unix, MS-Windows, EPOC, NT, MSCE, Linux, PalmOS, GEOS, VxWorks and all upgrades of these.

While presently preferred embodiments of the invention have been shown and described in particularity, those skilled in the art will recognize that the invention is not limited to the embodiments described herein. The invention may be otherwise embodied within the spirit and scope of the idea as set forth in the appended claims.

### CITED DOCUMENTS

[1] EP 0 860 788: Intelligent Transaction, Solid Information Technology Oy

[2] “Active Database Systems: Triggers and Rules For Advanced Database Processing” edited by Widom and Ceri, Morgan Kaufmann Publishers, 1996

1. A method for serially aligning database transactions comprising at least two databases coupled to their associated database management systems, comprising steps, in which
the first transaction is initiated in the first database,
at least one transaction trigger including attributes is linked into said first transaction,
said first transaction is ended in the first database,
is characterized in that, it further comprises step, in which at least one said trigger is fired in at least one first database and at least one second transaction is initiated in the first database to invoke a remote database operation in at least one second database according to at least some of the attributes in the trigger.

2. A method according to claim 1, characterized in that the said trigger is a deferred database operation defined for at least one data manipulation operation.

3. A method according to claim 1, characterized in that the execution of the second transaction is blocked until the said trigger fires.

4. A method according to claim 1, characterized in that, wherein a database system comprises at least one master database and at least one replica database, the data synchronization between the master and replica databases is master-initiated.

5. A method according to claim 1, characterized in that the transactionally consistent set of data in a database comprises configuration data.

6. A method according to claim 5, characterized in that the device changes its configuration to reflect the changed data right after the data has committed in the database.

7. A method according to claim 1, characterized in that the related software processes, like other database server or a client application, are informed about transactional changes by the data management server.

8. A method according to claim 1, characterized in that the method executes tasks and operations in a database transaction context.

9. A method according to claim 1, characterized in that, any of the said transactions are executed in separate database connections or in a shared connection with another said transaction or another transaction.

10. A method according to claim 1, characterized in that the method is compatible with at least one of the following communication specifications: TCP/IP, CDMA, GSM, HSCSD, GPRS, WCDMA, EDGE, UMTS, Bluetooth, Teldesic, Iridium, Inmarsat, WLAN, DIGI-TV and imode.

11. A method according to claim 1, characterized in that the method is compatible with at least one of the following operating systems and is used in at least one terminal including an application, replica database of the database system Unix, MS-Windows, EPOC, NT, MSCE, Linux, PalmOS, GEOS, VxWorks, Pocket PC and any upgrade of these.

12. A method according to claim 1, characterized in that at least one of the following operating systems is used in at least one server including an application master database of the database system: Unix, MS-Windows, VxWorks, NT and Linux and any upgrade of these.

13. A method for serially aligning database transactions comprising at least two databases coupled to their associated database management systems, comprising steps, in which
the first transaction is initiated in the first database,
at least one transaction trigger including attributes is linked into said first transaction,
said first transaction is ended in the first database,
is characterized in that, it further comprises step, in which at least one said trigger is fired in at least one first database and at least one second transaction is initiated to synchronize data in at least one second database from at least one first database according to at least some of the attributes in the trigger.

14. A method according to claim 13, characterized in that the set of data of the second transaction comprises data for performing push-style or push-pull-style synchronization.

15. A method according to claim 13, characterized in that the said trigger is a procedure call defined for at least one data manipulation operations.

16. A method according to claim 13, characterized in that the execution of the second transaction is blocked until the said trigger fires.

17. A method according to claim 13, characterized in that, wherein a database system comprises at least one master database and at least one replica database, the push synchronization data between the master and replica databases is master-initiated and pull synchronization data between the master and replica databases is replica-requested.

18. A method according to claim 13, characterized in that the transactionally consistent set of data in a database comprises system configuration data.

19. A method according to claim 18, characterized in that the device changes its configuration to reflect the changed data right after the data has committed in the database.

20. A method according to claim 13, characterized in that the related software processes, like other database server or a client application, are informed about transactional changes by the data management server.

21. A method according to claim 13, characterized in that the method executes tasks and operations in a database transaction context.

22. A method according to claim 13, characterized in that the method is compatible with at least one of the following communication specifications: TCP/IP, CDMA, GSM, HSCSD, GPRS, WCDMA, EDGE, UMTS, Bluetooth, Teldesic, Iridium, Inmarsat, WLAN, DIGI-TV and imode.

23. A method according to claim 13, characterized in that the method is compatible with at least one of the following operating systems and is used in at least one terminal including an application, replica database of the database system Unix, MS-Windows, EPOC, NT, MSCE, Linux, PalmOS, GEOS, VxWorks, Pocket PC and any upgrade of these.

24. A method according to claim 13, characterized in that at least one of the following operating systems is used in at least one server including an application master database of the database system: Unix, MS-Windows, VxWorks, NT and Linux and any upgrade of these.

25. A method according to claim 13, characterized in that, any of the said transactions are executed in separate database connections or in a shared connection with another said transaction or another transaction.

26. An arrangement for serially aligning database transactions comprising at least two databases and the associated database management system, comprising means for linking at least one transaction trigger including attributes into the first transaction in the first database, characterized in that, the arrangement further comprises means for initiating at least one second transaction to push data into at least one second database according to at least some of the attributes in the trigger after said first transaction is ended in the first database and thereafter said trigger is fired in at least one first database.

27. An arrangement according to claim 26, characterized in that it comprises at least one master database and one replica database coupled to associated database management systems.

28. An arrangement according to claim 26, characterized in that the transactionally consistent set of data in a database comprises system configuration data.

29. An arrangement according to claim 26, characterized in that at least the second database can be part of a router coupled to the application.

30. An arrangement according to claim 26, characterized in that a storage medium is a memory and/or a disk.

31. An arrangement according to claim 26, characterized in that the arrangement and/or database system is compatible with at least one of the following communication specifications: TCP/IP, CDMA, GSM, HSCSD, GPRS, WCDMA, EDGE, UMTS, Bluetooth, Teldesic, Iridium, Inmarsat, WLAN, DIGI-TV and imode.

32. An arrangement according to claim 26, characterized in that at least one of the following operating systems and is used in at least one terminal including an application, replica database of the database system Unix, MS-Windows, EPOC, NT, MSCE, Linux, PalmOS, GEOS, VxWorks, Pocket PC and any upgrade of these.

33. An arrangement according to claim 26, characterized in that at least one of the following operating systems is used in at least one server including an application master database server and/or the schema management node: Unix, MS-Windows, VxWorks, NT and Linux and any upgrade of these.

34. An arrangement for serially aligning database transactions comprising at least two databases and the associated database management system, comprising means for linking at least one transaction trigger including attributes into the first transaction in the first database, characterized in that, the arrangement further comprises means for initiating at least one second transaction to synchronize data in at least one second database from at least one first database according to at least some of the attributes in the trigger after said first transaction is ended in the first database and thereafter said trigger is fired in at least one first database.

35. An arrangement according to claim 34, characterized in that the set of data comprises data of push or push-pull synchronization.

36. An arrangement according to claim 34, characterized in that it comprises at least one master database and one replica database coupled to associated database management system.

37. An arrangement according to claim 34, characterized in that the transactionally consistent set of data in a database comprises system configuration data.

38. An arrangement according to claim 34, characterized in that at least the second database can be part of a router coupled to the application.

39. An arrangement according to claim 34, characterized in that a storage medium is a memory and/or a disk.

40. An arrangement according to claim 34, characterized in that the arrangement and/or the database system is compatible with at least one of the following communication specifications: TCP/IP, CDMA, GSM, HSCSD, GPRS, WCDMA, EDGE, UMTS, Bluetooth, Teldesic, Iridium, Inmarsat, WLAN, DIGI-TV and imode.

41. An arrangement according to claim 34, characterized in that at least one of the following operating systems is used in at least one terminal including an application, replica database of the database system Unix, MS-Windows, EPOC, NT, MSCE, Linux, PalmOS, GEOS, VxWorks, Pocket PC and any upgrade of these.

42. An arrangement according to claim 34, characterized in that at least one of the following operating systems is used in at least one server including an application master database server and/or the schema management node: Unix, MS-Windows, VxWorks, NT and Linux and any upgrade of these.
